(19) United States
(12) Patent Application Publication
(10) Pub. No.: US 2015/0270973 A1
(43) Pub. Date: Sep. 24, 2015

(54) DEVICE AND METHOD FOR CARRYING OUT A CRYPTOGRAPHIC METHOD

(71) Applicant: ROBERT BOSCH GMBH, Stuttgart (DE)

(72) Inventors: Paulius Duplys, Markgroeningen (DE); Matthew Lewis, Reutlingen (DE)

(21) Appl. No.: 14/435,980

(22) PCT Filed: Sep. 23, 2013
(86) PCT No.: PCT/EP2013/069657

§ 371 Date: Apr. 15, 2015

(30) Foreign Application Priority Data
Oct. 22, 2012 (DE) 10 2012 219 205.0

(51) Int. Cl. H04L 9/32

(52) U.S. Cl. CPC H04L 9/3242; H04L 2209/24

(57) ABSTRACT

A device for carrying out a cryptographic method includes: a cryptographic unit carrying out at least one step of the cryptographic method; and a functional unit carrying out a deterministic function as a function of input data supplied to the device and at least one secret key.

### BACKGROUND OF THE INVENTION

1. Field of the Invention

The present invention relates to a device and a method for carrying out a cryptographic process.

2. Description of the Related Art

Such devices and methods are known, for example from U.S. Pat. No. 7,599,488 B2.

The known device has a microprocessor core to which a random number generator is allocated in order to manipulate the execution of cryptographic instructions on the microprocessor core in a random manner. This makes cryptographic attacks on the microprocessor core carrying out the cryptographic method more difficult. In particular, so-called differential power analysis (DPA) attacks are made more difficult, because the temporal relationship between a regular clock signal and the actual execution of the individual steps of the cryptographic method by the microprocessor core is concealed using the random numbers.

A disadvantage of the known system is the fact that a random number generator is required, which can be realized only with a high technical expense, and a complex structure is also required of the periphery of the microprocessor core, which influences the clock signal for the microprocessor as a function of the random numbers.

### BRIEF SUMMARY OF THE INVENTION

Accordingly, the object of the present invention is to improve a device and a method of the type named above in such a way that the disadvantages of the existing art are avoided, while at the same time increased security is achieved in the carrying out of the cryptographic method, in particular security against so-called side-channel attacks, or DPA attacks.

According to the present invention, in the device of the type named above this object is achieved in that a functional unit is provided that is fashioned to carry out a deterministic function as a function of input data that can be supplied to the device, and as a function of at least one secret key. This results in the advantage that DPA attacks on the device are made more difficult, because in addition to the cryptographic function that is actually of interest that is carried out in the cryptographic unit, in addition the deterministic function is also carried out in the functional unit, so that electromagnetic radiation, energy signatures, and other features of the device that can be evaluated in the context of a DPA attack are always put together from components of both units (cryptographic unit and functional unit), or originate from these. This makes a precise analysis of the cryptographic unit more difficult.

For example, for two different sets of input data, e.g. in each case bit sequences having a length of 128 bits, the electrical power consumption of the device according to the present invention is a function of the input data sets and the secret key. Given a suitable length of the secret key, for example also 128 bits or more, in this way a DPA attack can be made more difficult in such a way that it cannot be successfully carried out with currently available computing power.

A further advantage of the present invention is that complex random generators and the like can be done without, because the functional unit according to the present invention uses a deterministic function and at least one secret key for it.

In an advantageous specific embodiment, it is provided that the cryptographic unit and the functional unit are each implemented as an integrated circuit, preferably in the same integrated circuit (IC), so that the advantageously achieved concealing of the electromagnetic radiation, energy signatures, etc., of the cryptographic unit is achieved to a particularly high degree. Through suitable selection of the circuit layout, further improvements in this regard can be achieved, for example by spatially integrating individual functional components of the functional unit in component regions of the cryptographic unit, and vice versa.

In a further advantageous specific embodiment, it is provided that the cryptographic unit and the functional unit have a common terminal for an electrical power supply, i.e. can be fed from the same energy source. In this way, the energy (consumption) signatures of the two units are superposed, which also makes DPA attacks more difficult.

In order to realize the advantages named above, it is not necessary to functionally use computing results or other quantities processed by the functional unit in the cryptographic unit. Rather, a “parallel operation,” in which both units (cryptographic unit and functional unit) operate also independently of one another and, at least at times, temporally overlapping one another, already suffices to conceal the features of the cryptographic unit that can be evaluated by DPA attacks.

In a further advantageous specific embodiment, it is provided that the functional unit is fashioned to form an output signal as a function of the input data and at least one part of the at least one secret key, and that the cryptographic unit is fashioned to carry out the cryptographic method, or the at least one step, as a function of the output signal of the functional unit. In contrast to the previous specific embodiments, in the present variant of the present invention during operation of the cryptographic unit data are used that are supplied by the functional unit, namely the output signal thereof. This achieves further increased security against DPA attacks.

At the same time, it is advantageously ensured that even an attacker who knows both the input data for the device and also output data encrypted thereby (e.g. AES-encrypted) cannot carry out a successful DPA attack, because the physical behavior of the cryptographic unit, e.g. its electrical energy consumption etc., is modified by the secret key in a manner not known to the attacker. Thus, as long as the secret key used by the functional unit according to the present invention is not known to the attacker, the device according to the present invention makes a DPA attack on the cryptographic unit more difficult, or even impossible given the currently available computational power of computers. Preferably, the secret key is stored internally in the functional unit, e.g. in the form of a read-only memory (ROM) or the like.

Particularly preferably, the use of the functional unit according to the present invention and its output signal does not change anything about the input data (plaintext) and the output data (ciphertext), i.e. for example the input data encrypted by the cryptographic unit of the device according to the present invention. Therefore, each device according to the present invention, or its functional unit integrated therein, can have a different secret key, which further increases security. The use of the functional unit according to the present invention therefore advantageously changes the physical behavior of the device, i.e. for example its energy signature, electromagnetic radiation, etc., but does not change its functional behavior with regard to the carrying out of cryptographic methods by the cryptographic unit.

In a further advantageous specific embodiment, it is provided that the functional unit is fashioned to form the output signal using a hash function.

In a further advantageous specific embodiment, it is provided that the functional unit is fashioned to:
1. Subject the input data and the key to an XOR operation in order to obtain first ORed data;
2. Partition the ORed data into a plurality of sub-blocks;
3. Subject a plurality of sub-blocks to an XOR operation among one another, in particular in multiple stages, in order to obtain second ORed data;
4. Subject the first and/or second ORed data to a non-linear substitution operation in order to obtain the output signal; and, if warranted,
5. Write the output signal to two shift registers inverse to one another.

In a further advantageous specific embodiment, it is provided that the cryptographic unit is fashioned to pre-load and/or to mask at least one storage register as a function of the output signal.

In a further advantageous specific embodiment, it is provided that the functional unit has a unit for carrying out a non-linear substitution operation. The non-linear substitution operation can be for example the SBOX method of the Advanced Encryption Standard (AES), or a comparable method.

In a further advantageous specific embodiment, it is provided that the cryptographic unit is fashioned to encrypt and/or to decrypt the input data, in particular in accordance with the Advanced Encryption Standard, AES. In addition, it is possible for the cryptographic unit to carry out only a single sub-step, or a plurality of sub-steps, of a cryptographic method.

In the following, exemplary embodiments of the present invention are explained with reference to the drawing.

### BRIEF DESCRIPTION OF THE DRAWINGS

FIG. 1 schematically shows a block diagram of a specific embodiment of a device according to the present invention.

FIG. 2 schematically shows a further specific embodiment of the device according to the present invention.

FIG. 3 schematically shows a further specific embodiment of the device according to the present invention.

FIG. 4 schematically shows a simplified block diagram of a functional unit according to the present invention.

FIG. 5 schematically shows a simplified block diagram of a storage register for use with the functional unit according to the present invention as shown in FIG. 4.

FIG. 6 schematically shows an aspect of an implementation of a functional unit according to the present invention.

FIG. 7 shows a simplified flow diagram of a specific embodiment of the method according to the present invention.

### DETAILED DESCRIPTION OF THE INVENTION

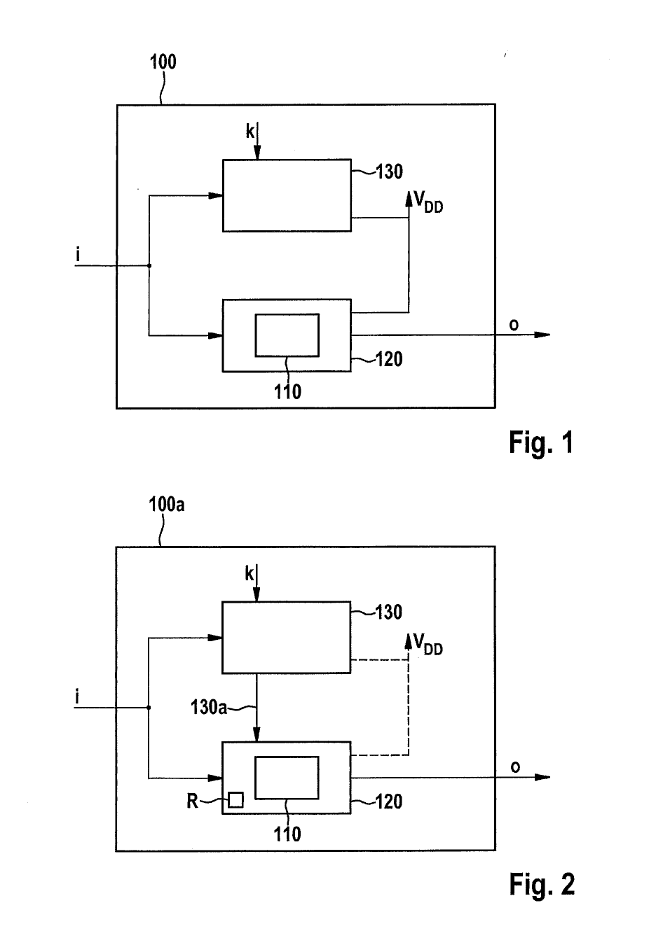

FIG. 1 schematically shows a block diagram of a first specific embodiment of device 100 according to the present invention. Device 100 has a cryptographic unit 120 that is fashioned to carry out a cryptographic method 110, or at least one step of a cryptographic method 110. An encryption according to the AES (Advanced Encryption Standard) may be taken as an example of a cryptographic method.

Device 100 is supplied with input data i that can be for example a bit sequence that is to be encrypted by cryptographic unit 120. Correspondingly, encrypted output data o are obtained at an output of cryptographic unit 120.

According to the present invention, device 100 has, in addition to cryptographic unit 120, a functional unit 130 that is fashioned to carry out a deterministic function as a function of the input data and of at least one secret key k.

The operation of functional unit 130 in parallel, at least at times, to the operation of cryptographic unit 120 makes differential power analysis (DPA) attacks on device 100 more difficult, because in addition to the actual cryptographic function 110 of interest, which is carried out in cryptographic unit. 120, the deterministic function is also carried out in functional unit 130, so that electromagnetic radiation, energy signatures (electrical power consumption or energy consumption), and other features of device 100 that can be evaluated in the context of a DPA attack are always put together from components of both units 120, 130, or originate from both these units. In this way, a precise analysis of cryptographic unit 120 is made more difficult. Cryptographic unit 120 and functional unit 130 can advantageously each be implemented as an integrated circuit, and are further preferably situated in the same integrated circuit.

In a further preferred specific embodiment, it is provided that cryptographic unit 120 and functional unit 130 have a common terminal for an electrical power supply, i.e. can be fed by the same energy source (not shown). In FIG. 1, this terminal is symbolized by line V_{DD}.

The supply of electrical energy in common to both components 120, 130 results, particularly advantageously, in a superposition of their energy signatures with regard to terminal point V_{DD} of connection to the electrical power source (not shown), so that DPA attacks can also be made more difficult at this location.

Alternatively to the configuration shown in FIG. 1, having a common supply of electrical energy to both components 120, 130, a separate supply of energy to both components 120, 130 is also possible.

Secret key k is preferably stored directly in device 100, or in functional unit 130, for example in the form of a ROM register.

In the specific embodiment of the present invention shown in FIG. 1, cryptographic unit 120 advantageously operates independently of functional unit 130, in the sense that operating quantities or output quantities of functional unit 130 are not used for the execution of cryptographic method 110 within cryptographic unit 120. Rather, the configuration of components 120, 130 spatially adjacent to one another, or the optional supply of electrical energy in common via common terminal V_{DD}, is already sufficient to superpose the energy signatures and electromagnetic radiation, and the like, of the two components 120, 130 in such a way that DPA attacks on device 100 or on cryptographic unit 120 are made more difficult.

In a further advantageous specific embodiment, it is provided that functional unit 130 forms an output signal 130a (FIG. 2) as a function of input data i and of secret key k, and that functional unit 130 outputs output signal 130a to cryptographic unit 120, cryptographic unit 120 being fashioned to carry out cryptographic method 110, or at least one step thereof, as a function of output signal 130a of functional unit 130, in this way providing further increased security against DPA attacks.

The supplying in common of electrical energy is indicated in FIG. 2 only by dashed lines, and can also be omitted, as mentioned above.

Particularly preferably, the above-described use of functional unit 130 according to the present invention, and of its output signal 130a (FIG. 2), in the context of the execution of cryptographic method 110 does not change anything about input data i and output data o. Therefore, each device 100a according to the present invention, or its functional unit 130 integrated therein, can have a different secret key k, which further increases the security of the system. The use of functional unit 130 according to the present invention and, if warranted, its output signal 130a thus advantageously changes the physical behavior of device 100, 100a, i.e. its energy signature, electromagnetic radiation, etc., but does not change its functional behavior with regard to the execution of cryptographic method 110 by cryptographic unit 120.

In a further specific embodiment, it is provided that functional unit 130 forms output signal 130a using a hash function.

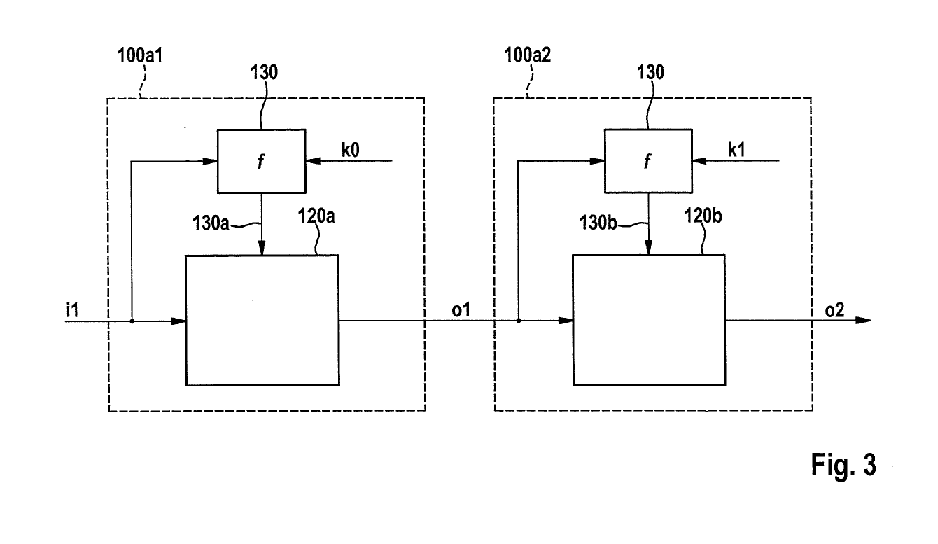

FIG. 3 schematically shows a block diagram of a further specific embodiment of the present invention. A first device 100a1 has a structure similar to that of device 100 shown in FIG. 1. Device 100a1 receives input data i1 at its input, and cryptographic unit 120a of device 100a1 is fashioned to subject input data i1 to an AES encryption in order to output correspondingly encrypted output data o1. Analogous to device 100 of FIG. 1, device 100a1 of FIG. 3 also has a functional unit 130 that in the present case forms its output signal 130a as a function of input data ii and of first secret key k0, using a deterministic function f. Second device 100a2 has a cryptographic unit 120b that is fashioned to decrypt the encrypted output data o1 using the AES, in order to obtain decrypted output data o2. To form its output signal 130b, functional unit 130 of device 100a2 uses input signal o1 supplied to device 100a2, as well as a second secret key k1 that is preferably different from first secret key k0 of functional unit 130 of first device 100a1. In this way, a further increase in the security of the operation of device 100a1, 100a2 is provided.

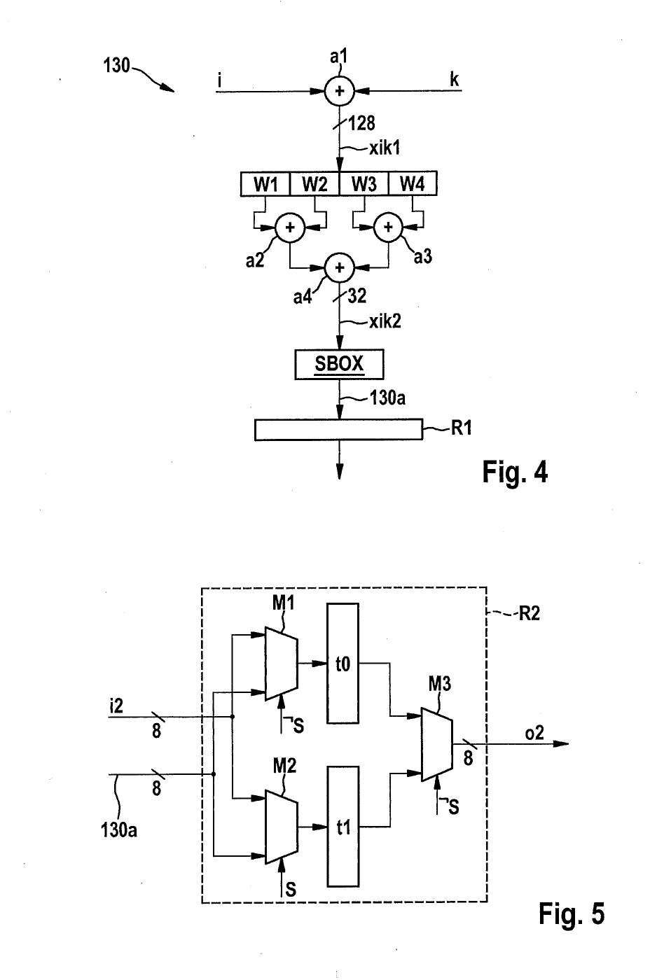

FIG. 4 schematically shows a simplified block diagram of a functional unit 130 according to the present invention. Functional unit 130 has a first XOR (exclusive OR) element al to which input data i (see also FIG. 1) and secret key k are supplied. In the present case, input data i and secret key k each have for example a length of 128 bits. Data i, k are linked to one another by XOR element a1 in an exclusive OR linkage, yielding first ORed data xik1, which in turn have a bit width of 128 bits.

In the present specific embodiment, first ORed data xik1, represented by a bit sequence of 128 bits length, are divided into four sub-blocks w1, w2, w3, w4, each having a length of 32 bits. Sub-blocks w1, w2 are then subjected to XOR linkage using further XOR element a2. The same holds for further sub-blocks w3, w4, which are XOR-linked using element a3. The output data of XOR elements a2, a3 are XOR-linked to one another by XOR element a4, whereby second ORed data xik2 are obtained, having a length of 32 bits.

According to FIG. 4, these second ORed data xik2 are subjected to a non-linear substitution operation that in the present case is carried out by the unit designated SBOX for carrying out a non-linear substitution operation.

As output data of the non-linear substitute operation SBOX, output signal 130a is obtained, which is preferably stored in an output register R1.

Output signal 130a can be provided, in the manner described several times above, to cryptographic unit 120 in order to influence the physical functioning of cryptographic unit 120, thus making DPA attacks more difficult.

FIG. 5 shows a simplified block diagram of a so-called DPA-hardened storage register R2, which receives, at its input, input data i2 as well as output signal 130a of functional unit 130 according to FIG. 4. Storage register R2, whose function is described in more detail below, can advantageously be used instead of register R1 in FIG. 4. That is, functional unit 130 according to FIG. 4 can provide its output signal 130a to storage register R2 according to FIG. 5 in the form of input signal 130a. Storage register R2 can for example also be contained in cryptographic unit 120.

The further input data i2 for storage register R2 can for example be input data i that are to be supplied to device 100 (FIG. 1) at the input side and are to be encrypted, or parts thereof.

As can be seen from FIG. 5, storage register R2 has two multiplexers M1, M2, to each of which are supplied output signal 130a and input data i2. As a function of a control signal s, which in the present case is a binary signal (only the values 1 or 0), second multiplexer M2 forwards either signal 130a or signal i2 to a register t1 situated downstream at the output side. Thus, either signal 130a or signal i2, or a corresponding bit location or corresponding data word thereof, is stored in register t1 as a function of control signal s for second multiplexer M2.

Because a control signal s that is the inverse of control signal s is supplied to first multiplexer M1, first multiplexer M1 accordingly also forwards either signal 130a or signal i2 to a register t0 situated downstream from the multiplexer at the output side, but in a manner inverse to second multiplexer M2. In other words, first multiplexer M1 forwards a bit of signal i2 to its output register t2 whenever second multiplexer M2 forwards a bit of signal 130a to its output register t1, and vice versa.

Instead of individual bits, it is also possible for components M1, M2, t0, t1 to simultaneously process data words, etc., having a plurality of bits.

FIG. 5 shows that the outputs of registers t0, t1 are supplied to a third multiplexer M3 that outputs either the output signal of register t0 or of register t1 as output signal o2 of register R2 as a function of inverse control signal s.

Output data o2 of the device of FIG. 5 are advantageously processed in the context of cryptographic method 110, for example using an AES encryption, whereby the output data o of device 100 are obtained; cf. FIG. 1.

Storage register R2 of FIG. 5 causes—possibly with simultaneous use of the implementation of function f (FIG. 1) according to FIG. 4 for functional unit 130—a much more complex energy and radiation signature than does a conventional cryptographic unit alone. Therefore, a specific embodiment of the present invention having one or both of the components 130, R2 according to FIG. 4 or FIG. 5 has further increased security against DPA attacks.

However, other specific embodiments are also conceivable for function f (FIG. 1) of functional unit 130, in which for example output signal 130a of functional unit 130 is formed differently than is shown in FIG. 4 (preferably, again as a function of input data i and of secret key k) and is then used to modify a physical behavior of cryptographic unit 120, but not its functional behavior (carrying out the cryptographic method).

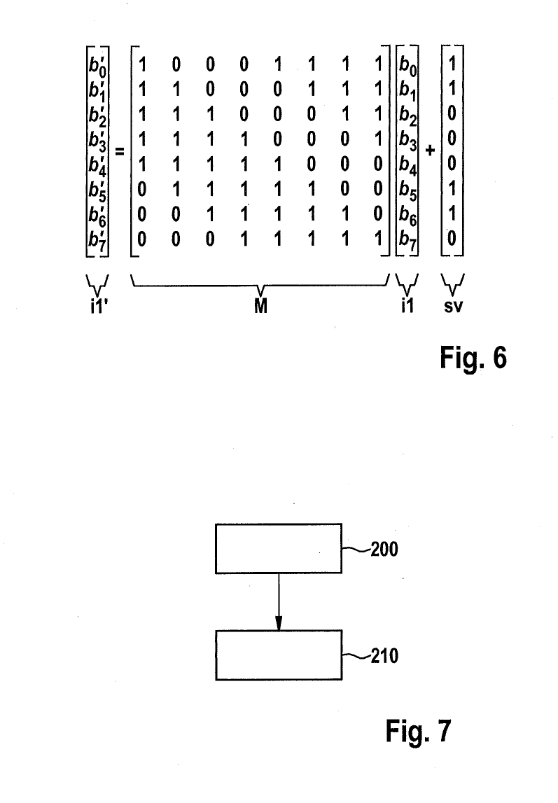

The SBOX or S-BOX (substitution box) unit for carrying out a non-linear substitution operation according to FIG. 4 can for example be implemented in the manner shown by the matrix equation of FIG. 6. FIG. 6 shows a column vector i1 having, in this case, a total of eight elements (e.g. each one bit) b0, . . . , b7, representing examples of input data for the non-linear substitution operation. Column vector i1 is multiplied by matrix M and the resulting matrix product M×i1 is then additively linked with further column vector sv, resulting in column vector i1′, which represents the output data of the non-linear substitution operation.

Advantageously, given the non-linear substitution operation illustrated by FIG. 6, even slight changes in input data i1 of for example only one bit location b5 result, as a rule, in significantly larger changes in output data i1′, in which frequently a plurality, preferably more than four, bit locations are affected.

The matrix equation shown in FIG. 6 is indicated only as an example in order to illustrate the principle of an S-BOX, and can be modified both with regard to the values of elements M, SV and with regard to the dimension of matrix M, or the vectors i1, SV that are involved. For example, the SBOX shown in FIG. 4 can work with vectors i1, sv having 32 bits, and accordingly can also provide an output vector i1′ having 32 bits.

Particularly advantageously, a functional unit 130 according to the present invention can be provided with the functionality shown in FIG. 6 of a non-linear substitution operation; it is also conceivable to select at least one of the components M, sv, or their elements, as a function of secret key k (FIG. 1).

FIG. 7 shows a simplified flow diagram of a specific embodiment of the method according to the present invention. In a first step 200, functional unit 130 (FIG. 1) forms its output signal 130a as a function of input data i and at least a part of the at least one secret key k. In the following step 210 (FIG. 7), cryptographic unit 120 (FIG. 1) carries out a cryptographic method 110, e.g. an AES algorithm or the like.

The present invention advantageously makes DPA attacks on device 100 more difficult, because in addition to cryptographic function 110 that is actually of interest and is carried out in cryptographic unit 120, in addition deterministic function f is also carried out in functional unit 130, so that electromagnetic radiation, energy signatures, and other features of device 100 that can be evaluated in the context of a DPA attack are always put together from components of both units 120, 130. In this way, a precise analysis of cryptographic unit 120, or its function 110, is made more difficult.

For example, for two different input data sets, e.g. each bit sequences having a length of 128 bits, an electrical power consumption of device 100, 100a according to the present invention is a function of input data sets i and secret key k. Given a suitable length of the secret key of for example 128 bits or more in the field, in this way a DPA attack can be made more difficult, in such a way that it cannot successfully be carried out with currently available computing power.

In a preferred specific embodiment, deterministic function f of functional unit 130 can for example be fashioned as shown in FIG. 4. In this case, cryptographic unit 120 can for example also have a storage register R2 of the type described in FIG. 5.

1-12. (canceled)

13. A device for carrying out a cryptographic method, comprising:
a cryptographic unit carrying out at least one step of the cryptographic method; and
a functional unit carrying out a deterministic function as a function of input data supplied to the device and at least one secret key.

14. The device as recited in claim 13, wherein the cryptographic unit and the functional unit are each implemented as an integrated circuit.

15. The device as recited in claim 13, wherein the cryptographic unit and the functional unit have a common terminal for an electrical power supply.

16. The device as recited in claim 13, wherein the functional unit forms an output signal as a function of the input data and at least a part of the at least one secret key, and wherein the cryptographic unit carries out the at least one step of the cryptographic method as a function of the output signal of the functional unit.

17. The device as recited in claim 16, wherein the functional unit forms the output signal using a hash function.

18. The device as recited in claim 16, wherein the functional unit is configured to:
a. subject the input data and the key to an XOR operation in order to obtain first ORed data;
b. partition the ORed data into a plurality of sub-blocks;
c. subject the plurality of sub-blocks to an XOR operation among one another in order to obtain second ORed data;
d. subject at least one of the first and second ORed data to a non-linear substitution operation in order to obtain the output signal; and
e. write the output signal to two shift registers inverse to one another.

19. The device as recited in claim 16, wherein the cryptographic unit at least one of pre-loads and masks at least one storage register as a function of the output signal.

20. The device as recited in claim 16, wherein the functional unit has a unit for carrying out a non-linear substitution operation.

21. The device as recited in claim 16, wherein the cryptographic unit at least one of encrypts and decrypts the input data.

22. A method for operating an electronic device for carrying out a cryptographic process, comprising:
performing, using a cryptographic unit of the electronic device, at least one step of the cryptographic process: and
carrying out, by a functional unit of the electronic device, a deterministic function as a function of input data supplied to the electronic device and at least one secret key.

23. The method as recited in claim 22, wherein the cryptographic unit and the functional unit use a common terminal for a supply of electrical power.

24. The method as recited in claim 22, wherein the functional unit forms an output signal as a function of the input data and at least of one part of the at least one secret key, and wherein the cryptographic unit carries out the at least one step of the cryptographic process as a function of the output signal of the functional unit.
